(19) United States
(12) Patent Application Publication
(10) Pub. No.: US 2004/0124060 A1
(43) Pub. Date: Jul. 1, 2004

(54) Wheel driving device for pedal propelled cycle

(76) Inventor: Kun-Teng Chen, Taichung Hsien (TW)

Correspondence Address: TROP PRUNER & HU, PC, 8554 KATY FREEWAY, SUITE 100, HOUSTON, TX, 77024, US

(21) Appl. No.: 10/331,581

(22) Filed: Dec. 30, 2002

(51) Int. Cl. F16D 67/02

(52) U.S. Cl. 192/217.6; 192/19

(57) ABSTRACT

A wheel driving device for a pedal propelled cycle, includes an axle coupled with cranks and driven to rotate synchronously by a pedaling force. A coupling socket is movable axially as a result of a rotation of the axle between a fully engaged position, where it is in a full threaded engagement with the axle and frictionally engages a hub shell so as to move a wheel body forward, and a partially engaged position, where it is in a partial threaded engagement with the axle as a result of a screwing-out movement due to backpedaling, and disengages from the hub shell so as to place the wheel body in a freewheeling state. Further backpedaling results in a frictional engagement of the coupling socket with a brake member so as to brake the hub shell and the wheel body.

### BACKGROUND OF THE INVENTION

1. Field of the Invention

This invention relates to a wheel driving device for a pedal propelled cycle, more particularly to a wheel driving device for a pedal propelled cycle which includes left and right cranks provided with left and right pedals for rotating a front wheel axle.

2. Description of the Related Art

Referring to FIG. 1, a conventional wheel driving device for a rear wheel of a bicycle is shown to include an axle 1 which is secured on a rear wheel frame 8, a driving barrel 2 which rotatably surrounds the axle 1, a mount member 3, a hub shell 4 for connecting with a rear wheel (not shown), a coil spring 5, a coupling socket 6, and two brake members 7. The driving barrel 2 includes a coupling segment 201 on which a sprocket wheel (not shown) is mounted, and an externally threaded surface 202. The mount member 3 includes a tubular mount 301 surrounding the axle 1 and having a first friction surface 3011, and a lever 302 disposed for suspending the tubular mount 301 from the rear wheel frame 8. The hub shell 4 has an annular second friction surface 401. The coil spring 5 is disposed around the axle 1, abuts against left and right limit members 501, 502, and is confined between the tubular mount 301 and the coupling socket 6. The coupling socket 6 has an internally threaded segment 601 which engages threadedly the externally threaded surface 202, a third friction surface 602 which confronts the second friction surface 401, and a fourth friction surface 603 opposite to the third friction surface 602. Each of the brake members 7 is disposed between the tubular mount 301 and the coupling socket 6, and has fifth and sixth friction surfaces 701, 702 which confront the fourth and first friction surface 603, 3011, respectively.

Thus, the coupling socket 6 is movable axially by a rotational force of the driving barrel 2 through the engagement of the internally threaded segment 601 and the externally threaded surface 202 between a fully engaged position, where the third friction surface 602 is frictionally engaged with the second friction surface 401 to result in a rotation of the hub shell 4 and the rear wheel, and a partially engaged position as a result of a screwing-out movement of the internally threaded segment 601 relative to the externally threaded surface 202 due to backpedaling, where the third friction surface 602 is disengaged from the second friction surface 401, thereby placing the rear wheel in a freewheeling state. Further backpedaling brings the coupling socket 6 to move away from the second friction surface 401 until the fourth friction surface 603 is frictionally engaged with the fifth friction surface 701 such that outer surrounding walls of the brake members 7 abut frictionally against the hub shell 4 and such that the sixth friction surface 702 is engaged frictionally with the first friction surface 3011 so as to brake the rotation of the hub shell 4 and the rear wheel.

Since the coupling socket 6 is driven to move by means of the driving barrel 2, and since the axle 1 is fixed on the rear wheel frame 8, the conventional wheel driving device is not suitable for use in a cycle, such as an acrobatic tricycle, which has a rotatable front wheel axle that is coupled with and that is driven by pedaling cranks for rotating a front wheel body.

### SUMMARY OF THE INVENTION

The object of the present invention is to provide a wheel driving device for use in a pedal propelled cycle, which has a rotatable axle that is driven by pedaling cranks of the cycle, which has a rotatable axle that is driven by pedaling cranks of the rotation, idle running and braking of a wheel body of the cycle.

According to this invention, the wheel driving device includes an axle which has left and right mounted portions opposite to each other in an axial direction. The left and right mounted portions are adapted to be rotatably mounted on and to extend outboard to left and right mounts of a pedal propelled cycle, and terminate at left and right ends respectively. The left and right ends are adapted to couple with left and right cranks of the cycle, respectively, and to be driven to rotate synchronously by a drive force acting on one of left and right pedals. Left and right annular race segments are opposite to each other in the axial direction, and are inboard to the left and right mounted portions, respectively. Abutting and engaging segments are opposite to each other in the axial direction, and are inboard to the left and right annular race segments, respectively. The engaging segment has an externally threaded surface.

A hub shell has first and second lateral ends which are disposed opposite to each other in the axial direction, and an inner peripheral wall surface which extends in the axial direction to communicate the first and second lateral ends and which is spaced apart from the abutting and engaging segments to confine a surrounding accommodation space. The inner peripheral wall surface includes first and second wall portions respectively proximate to the first and second lateral ends, and an intermediate wall portion interposed between the first and second wall portions. The first wall portion has a first friction wall surface.

Left and right antifriction bearings are respectively disposed between the second lateral end and the left annular race segment, and between the first lateral end and the right annular race segment. As such, the intermediate wall portion and the first wall portion are disposed to surround and to be rotatable relative to the abutting segment and engaging segments, respectively. The first friction wall surface confronts the engaging segment in a radial direction relative to the axis.

A coupling socket is disposed in the surrounding accommodation space, and is movable relative to the intermediate wall portion in the axial direction. The coupling socket includes engaging and coupling ends opposite to each other in the axial direction. The engaging end has a second friction wall surface which confronts the first friction wall surface, and an internally threaded portion which is disposed opposite to the second friction wall surface radially and which is movable in the axial direction between a fully engaged position and a partially engaged position. In the fully engaged position, the externally threaded surface is in a full threaded engagement with the internally threaded portion as a result of a clockwise rotation of one of the left and right ends of the axle, which corresponds to a forward movement of the wheel body, such that the second friction wall surface is frictionally engaged with the first friction wall surface to transmit the drive force through the engaging segment to the hub shell, thereby rotating the wheel body. In the partially engaged position, the externally threaded surface is in a partial threaded engagement with the internally threaded portion as a result of a screwing-out movement of the internally threaded portion relative to the externally threaded surface, and the second friction wall surface is disengaged from the first friction wall surface to place the wheel body in a freewheeling state. The coupling end extends towards the second lateral end.

A coil spring is disposed around the abutting segment to bias the second friction wall surface to move towards the first friction wall surface. As such, when the clockwise rotation of the corresponding one of the left and right ends is terminated suddenly by arresting turning movement of the left and right pedals while the forward movement of the wheel body continues as a result of inertia, the internally threaded portion rotates relative to the externally threaded surface in a screwing-out movement against biasing action of the coil spring so as to be disposed in the partially engaged position, thereby placing the wheel body in the freewheeling state.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a partly sectional view of a conventional wheel driving device in an assembled state;

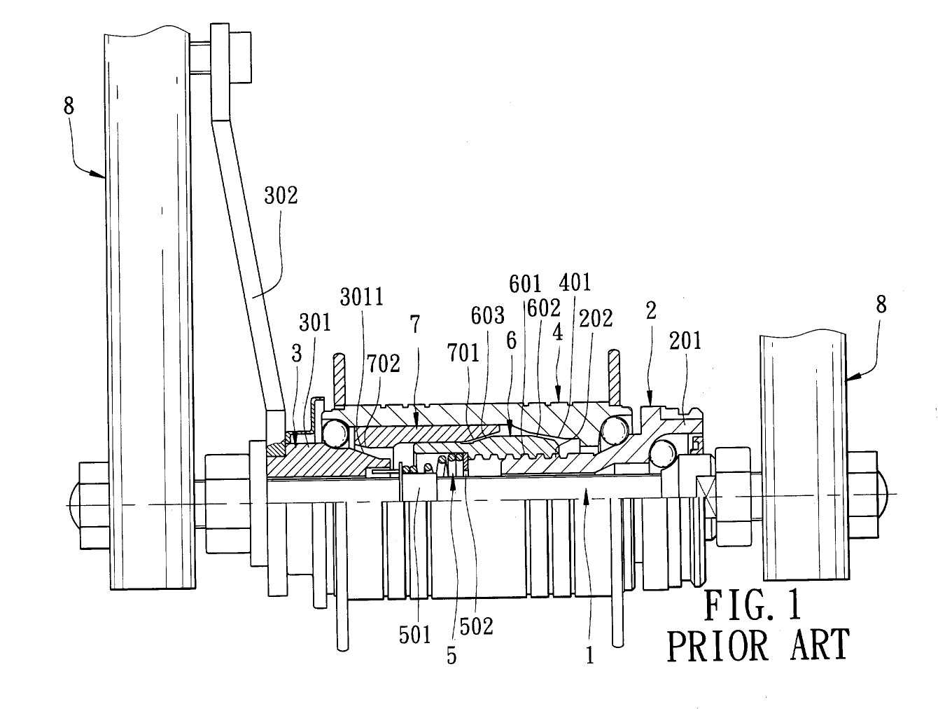

FIG. 2 is a perspective view of an acrobatic tricycle incorporating a preferred embodiment of a wheel driving device according to this invention;

FIG. 3 is a partly sectional view of the preferred embodiment of this invention;

FIG. 4 is an exploded perspective view of a portion of the preferred embodiment;

FIG. 5 is a partly sectional view of the preferred embodiment, showing that an internally threaded segment of a coupling socket is in a fully engaged position;

FIG. 6 is a partly sectional view of the preferred embodiment, showing that the internally threaded segment of the coupling socket is in a partially engaged position, and that a brake member is in a freewheeling position; and

FIG. 7 is a partly sectional view of the preferred embodiment, showing that the brake member is in a braked position.

### DETAILED DESCRIPTION OF THE PREFERRED EMBODIMENT

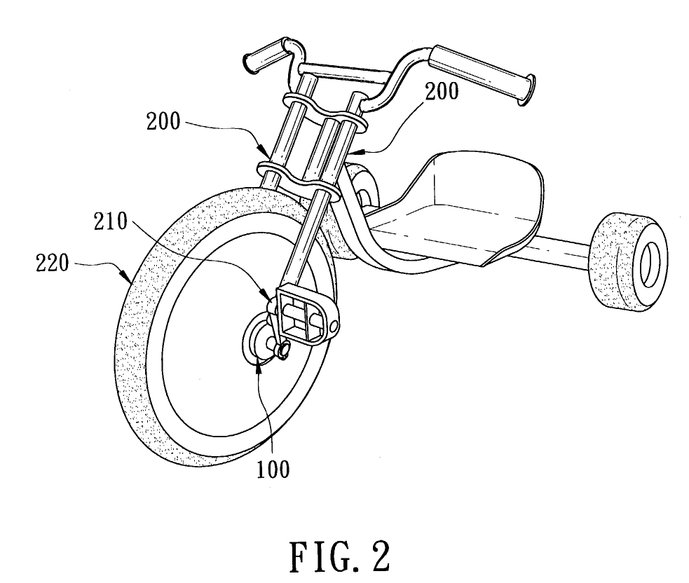

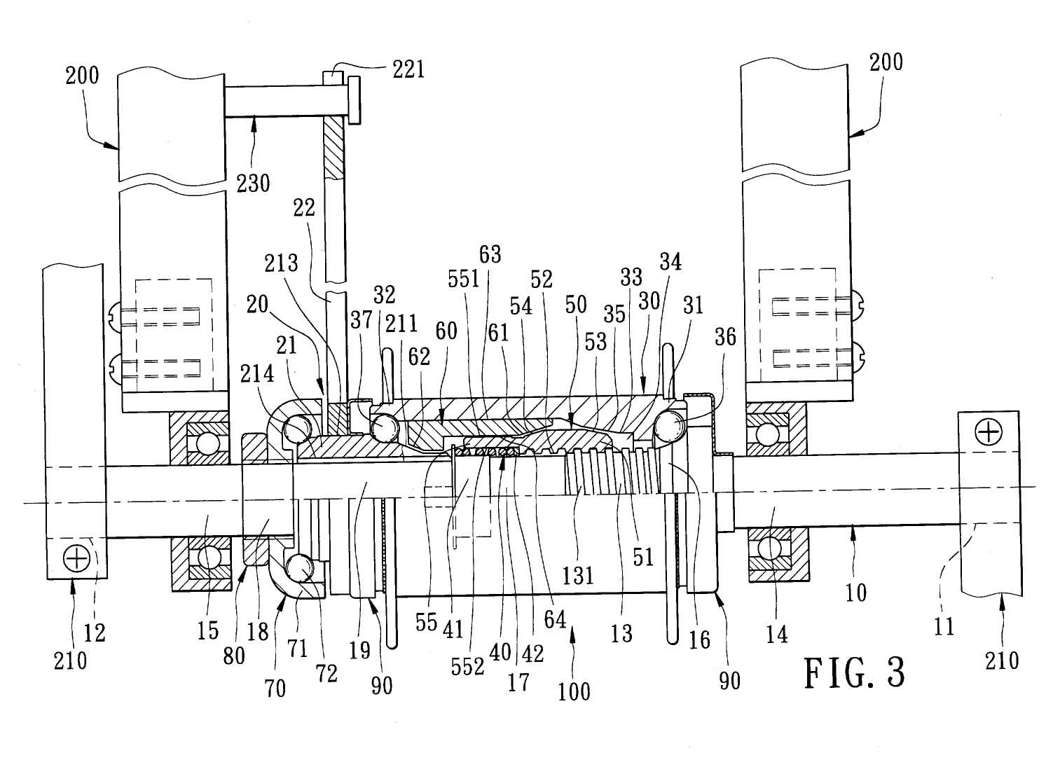

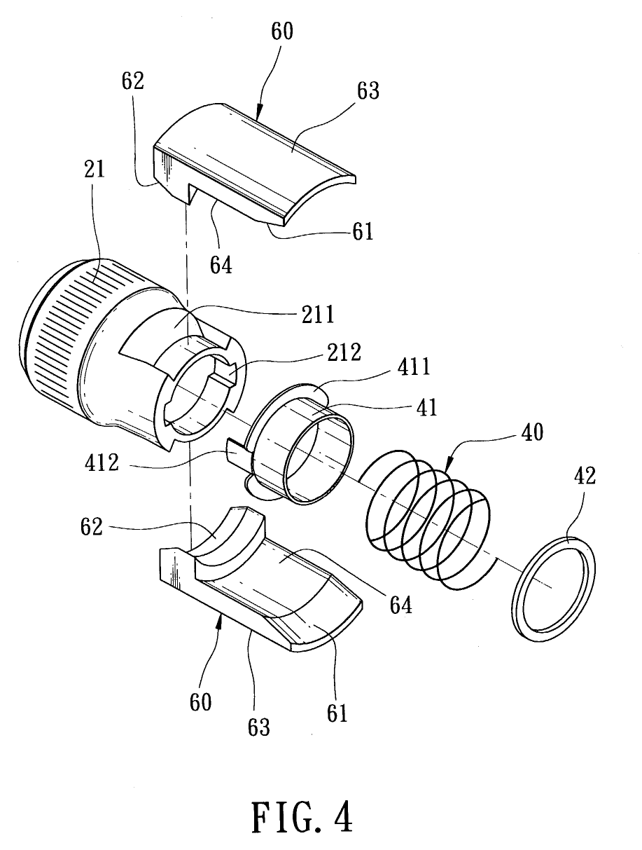

Referring to FIGS. 2 and 3, the preferred embodiment of a wheel driving device 100 according to the present invention is shown to be adapted to be mounted on a front wheel frame of an acrobatic tricycle. The front wheel frame includes left and right mounts 200 spaced apart from each other in an axial direction. A front wheel body 220 is disposed between and is rotatable relative to the left and right mounts 200 about an axis. Left and right cranks 210 are respectively provided with left and right pedals for driving the front wheel body 220 to rotate about the axis. The wheel driving device 100 is shown to comprise an axle 10, a mount member 20, a hub shell 30, a coupling socket 50, a coil spring 40, and two brake members 60 (see FIG. 4).

Referring to FIGS. 3 and 4, the axle 10 includes left and right mounted portions 15, 14 opposite to each other in the axial direction. The left and right mounted portions 15, 14 are adapted to be rotatably mounted on and to extend outboard to the left and right mounts 200, respectively, and terminate at left and right ends 12, 11, respectively, which are adapted to couple with the left and right cranks 210, respectively, and to be driven to rotate synchronously by a drive force acting on one of the left and right pedals. Left and right annular race segments 18, 16 are disposed opposite to each other in the axial direction and inboard to the left and right mounted portions 15, 14, respectively. Abutting and engaging segments 17, 13 are disposed opposite to each other in the axial direction and inboard to the left and right annular race segments 18, 16, respectively. The engaging segment 13 has an externally threaded surface 131. An interconnecting segment 19 is interposed between the left annular race segment 18 and the abutting segment 17.

The mount member 20 includes a tubular mount 21 which has outer and inner tubular surfaces 213, 214 opposite to each other in radial directions relative to the axis. The outer tubular surface 213 is connected securely to a securing lever 22 so as to be suspended from the left mount 200 by means of a stem 230 that engages a positioning notch 221, and includes a friction region 211 which is disposed proximate to the abutting segment 17. The inner tubular surface 214 is disposed to surround the interconnecting segment 19 of the axle 10, and permits rotation of the interconnecting segment 19 relative thereto, and has two inner holding grooves 212 (see FIG. 4) formed therein.

The hub shell 30 has first and second lateral ends 31, 32 which are disposed opposite to each other in the axial direction and which are covered by two covers 90, and an inner peripheral wall surface 33 which extends in the axial direction to communicate the first and second lateral ends 31, 32 and which is disposed to be spaced apart from the abutting and engaging segments 17, 13 in radial directions relative to the axis so as to confine a surrounding accommodation space 34. The friction region 211 of the tubular mount 21 extends into the surrounding accommodation space 34. The inner peripheral wall surface 33 includes first and second wall portions respectively proximate to the first and second lateral ends 31, 32, and an intermediate wall portion interposed therebetween. The first wall portion has a first friction wall surface 35.

Left and right antifriction bearings 70, 36 are respectively disposed between the second lateral end 32 of the hub shell 30 and the tubular mount 21, and between the first lateral end 31 of the hub shell 30 and the right annular race segment 16. The left antifriction bearing 70 includes outer and inner annular race regions which are disposed on the outer tubular surface 213 of the tubular mount 21 and which are respectively distal from and proximate to the friction region 211 in the axial direction. A bowl-shaped race member 71 is mounted threadedly on the left annular race segment 18 of the axle 10, and confronts the outer annular race region. A plurality of first rollers 37 and a plurality of second rollers 72 are respectively disposed between the outer annular race region and the bowl-shaped race member 71, and between the inner annular race region and the second lateral end 32 of the hub shell 30. A screw fastener 80 is mounted threadedly on the left annular race segment 18 so as to adjustably fasten the bowl-shaped race member 71 on the left annular race segment 18.

Thus, the intermediate wall portion and the first wall portion of the inner peripheral wall surface 33 of the hub shell 30 surround and are rotatable relative to the abutting segment 17 and the engaging segment 13, respectively. The first friction wall surface 35 confronts the engaging segment 13 in a radial direction relative to the axis.

The coupling socket 50 is disposed in the surrounding accommodation space 34, and is movable relative to the intermediate wall portion of the inner peripheral wall surface 33 in the axial direction. The coupling socket 50 includes an engaging end 51 and a coupling end 55 opposite to each other in the axial direction.

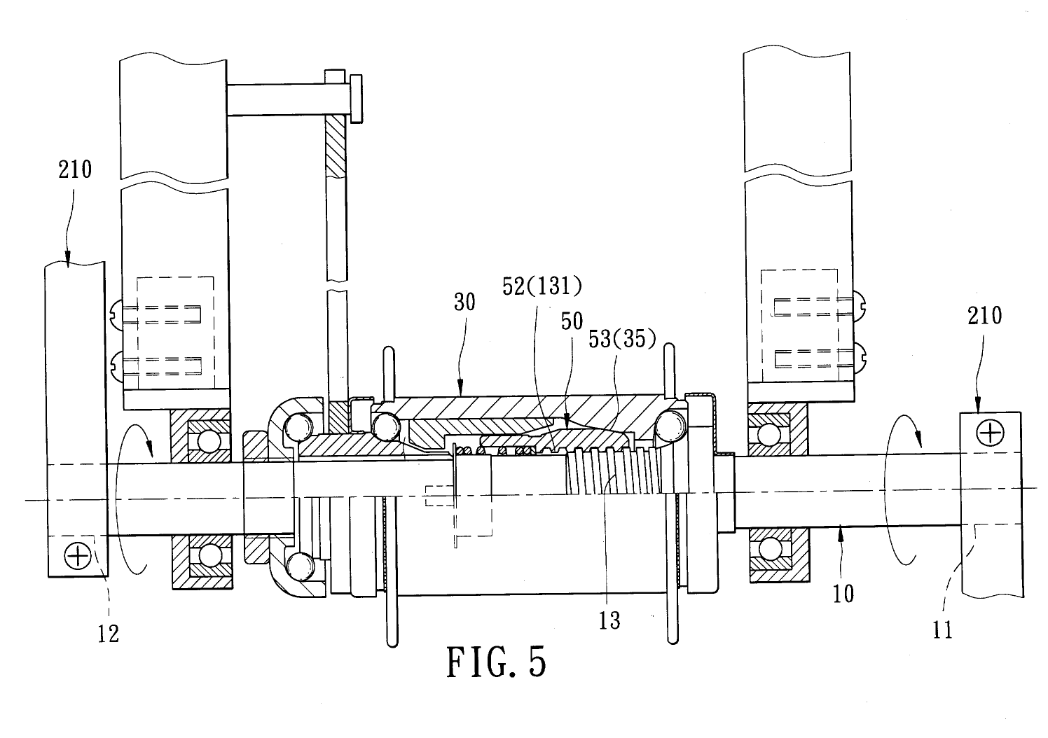

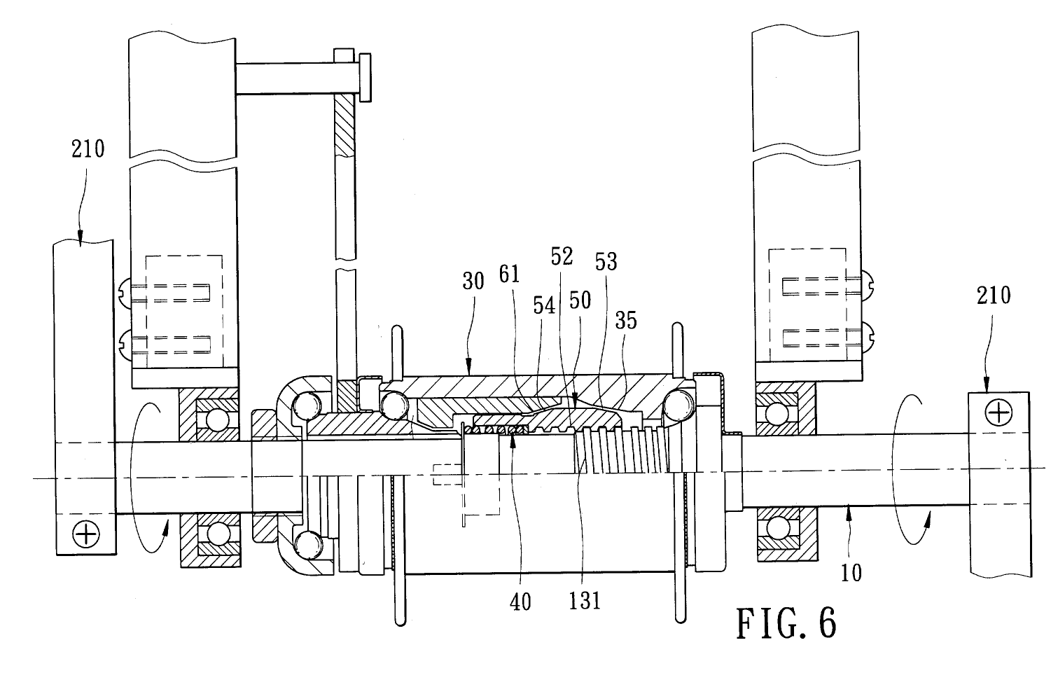

The engaging end 51 has a second friction wall surface 53 which confronts the first friction wall surface 35, and an internally threaded portion 52 which is disposed opposite to the second friction wall surface 53 radially and which is movable in the axial direction between a fully engaged position (as shown in FIG. 5) and a partially engaged position (as shown in FIG. 6). In the fully engaged position, referring to FIG. 5, the externally threaded surface 131 of the engaging segment 13 is in a full threaded engagement with the internally threaded portion 52 as a result of a clockwise rotation of one of the left and right ends 12, 11 of the axle 10, which corresponds to a forward movement of the front wheel body 220 (see FIG. 2). As such, the second friction wall surface 53 is frictionally engaged with the first friction wall surface 35 to transmit the drive force through the engaging segment 13 to the hub shell 30, thereby rotating the front wheel body 220. In the partially engaged position, referring to FIG. 6, the externally threaded surface 131 of the engaging segment 13 is in a partial threaded engagement with the internally threaded portion 52 as a result of a screwing-out movement of the internally threaded portion 52 relative to the externally threaded surface 131, such that the second friction wall surface 53 is disengaged from the first friction wall surface 35 to place the front wheel body 220 in a freewheeling state.

The engaging end 51 further has a third friction wall surface 54 which is disposed opposite to the second friction wall surface 53 in the axial direction and which confronts the intermediate wall portion of the inner peripheral wall surface 33 in a radial direction relative to the axis.

The coupling end 55 extends towards the second lateral end 32 of the hub shell 30, and includes a tubular portion to receive and to surround the abutting segment 17 and the coil spring 40 that is disposed around the abutting segment 17. The tubular portion has outer and inner surrounding surfaces 551, 552 opposite to each other in radial directions relative to the axis. A left limit member 41 has two protruding portions 412 which are respectively inserted into the inner holding grooves 212 so as to be disposed on the abutting segment 17 of the axle 10 proximate to the friction region 211. The left limit member 41 further has an abutting surface 411 (FIG. 4) for abutment of one end of the coil spring 40 thereagainst. A right limit member 42 is in the form of a ring which is spaced apart from the left limit member 41 in the axial direction, and is disposed on the inner surrounding surface 552 for abutment of the other end of the coil spring 40 thereagainst. The left and right limit member 41, 42 cooperate to confine the coil spring 40 therebetween so as to permit the coil spring 40 to bias the second friction wall surface 53 to move towards the first friction wall surface 35.

As such, when the clockwise rotation of the corresponding one of the left and right ends 12, 11 of the axle 10 is terminated suddenly by arresting the turning movement of a corresponding one of the left and right pedals while the forward movement of the front wheel body 220 continues as a result of inertia, the internally threaded portion 52 rotates relative to the externally threaded surface 131 in a screwing-out movement against biasing action of the coil spring 40 so as to be disposed in the partially engaged position, thereby placing the front wheel body 220 in the freewheeling state, as shown in FIG. 6.

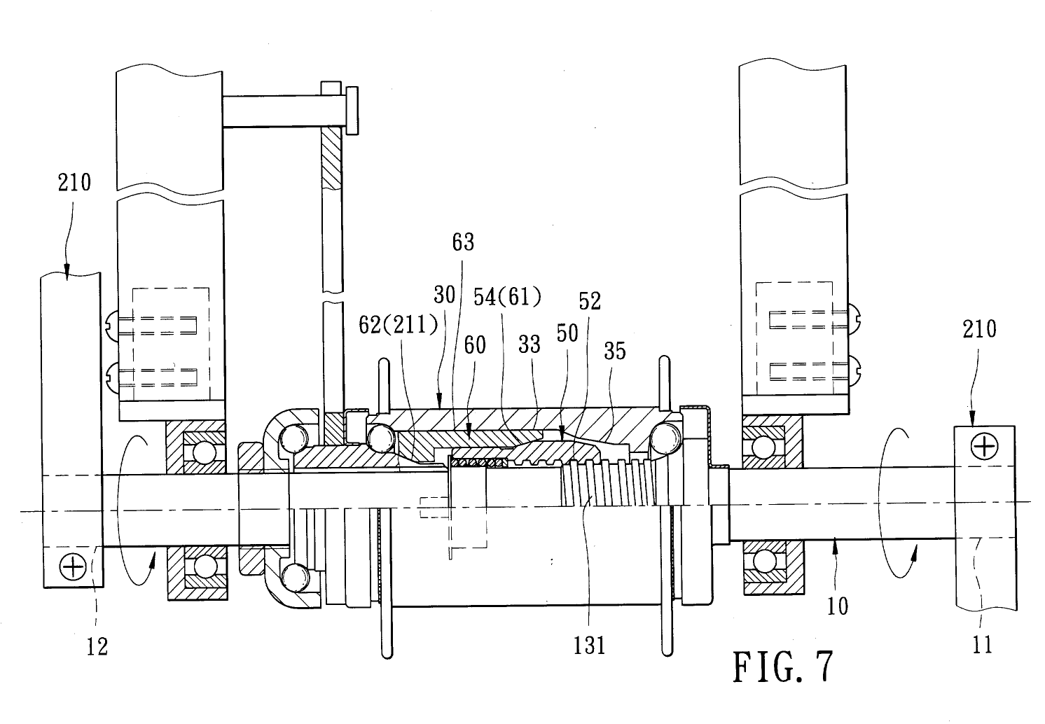

Each of the brake members 60 is disposed in the surrounding accommodation space 34, and has a fourth friction wall surface 61 which confronts the third friction wall surface 54 of the coupling socket 50, an abutment wall surface 63 which is opposite to the fourth friction wall surface 61 in a radial direction relative to the axis and which is disposed to confront the inner peripheral wall surface 33 of the hub shell 30, and a fifth friction wall surface 62 which is opposite to the fourth friction wall surface 61 in the axial direction and which is disposed to confront the friction region 211 of the tubular mount 21. In addition, each of the brake members 60 further has an inner surrounding guiding wall 64 which extends in the axial direction and which communicates with the fourth friction wall surface 61 to receive and surround the tubular portion of the coupling end 55 of the coupling socket 50. The inner surrounding guiding wall 64 is in slidable contact with the outer surrounding surface 551 of the tubular portion so as to stabilize movement of the coupling socket 50 in the axial direction between a freewheeling position (see FIG. 6) and a braked position (see FIG. 7).

In the freewheeling position, referring to FIG. 6, the internally threaded portion 52 of the engaging end 51 of the coupling socket 50 is in the partial threaded engagement with the externally threaded surface 131 of the engaging segment 13 as mentioned above, and the third friction wall surface 54 is disengaged from the fourth friction wall surface 61. In the braked position, referring to FIG. 7, the internally threaded portion 52 is in a slight threaded engagement with the externally threaded surface 131 as a result of a counterclockwise rotation of the axle 10 due to backpedaling. In addition, the fourth and fifth friction wall surfaces 61, 62, and the abutment wall surface 63 respectively engage the third friction wall surface 54, the friction region 211 and the inner peripheral wall surface 33 of the hub shell 30 as a result of a leftward displacement of the brake member 60 due to movement of the internally threaded portion 52 from the freewheeling position to the braked position, thereby stopping the front wheel body 220. Thus, the rider can swing the rear wheel part of the tricycle to perform acrobatic maneuvers.

As illustrated, the coupling socket 50 is movable in the axial direction as a result of the rotation of the axle 10 by the drive force acting on one of the left and right pedals so as to result in rotation, idle running or braking of the front wheel body 220. Therefore, the wheel driving device 100 of this invention can be adapted for use in a pedal propelled cycle that has left and right cranks to rotate directly an axle so as to rotate a front wheel of the cycle.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A wheel driving device for a pedal propelled cycle which includes left and right mounts spaced apart from each other in an axial direction, a wheel body disposed between and rotatable relative to the left and right mounts about an axis, and left and right cranks provided respectively with left and right pedals for driving the wheel body to rotate about the axis, said wheel driving device comprising:
an axle including
left and right mounted portions opposite to each other in the axial direction, said left and right mounted portions being adapted to be rotatably mounted on and to extend outboard to the left and right mounts, respectively, and terminating at left and right ends, respectively, said left and right ends being adapted to couple with the left and right cranks, respectively, and to be driven to rotate synchronously by a drive force acting on one of the left and right pedals,
left and right annular race segments opposite to each other in the axial direction and inboard to said left and right mounted portions, respectively, and
abutting and engaging segments opposite to each other in the axial direction and inboard to said left and right annular race segments, respectively, said engaging segment having an externally threaded surface;
a hub shell having first and second lateral ends which are disposed opposite to each other in the axial direction, and an inner peripheral wall surface which extends in the axial direction to communicate said first and second lateral ends and which is disposed to be spaced apart from said abutting and engaging segments in radial directions relative to the axis to confine a surrounding accommodation space, said inner peripheral wall surface including first and second wall portions respectively proximate to said first and second lateral ends, and an intermediate wall portion interposed between said first and second wall portions, said first wall portion having a first friction wall surface;
left and right antifriction bearings respectively disposed between said second lateral end and said left annular race segment, and between said first lateral end and said right annular race segment, such that said intermediate wall portion and said first wall portion are disposed to surround and to be rotatable relative to said abutting segment and said engaging segments, respectively, and such that said first friction wall surface confronts said engaging segment in a radial direction relative to the axis;
a coupling socket disposed in said surrounding accommodation space, and movable relative to said intermediate wall portion in the axial direction, said coupling socket including
an engaging end having a second friction wall surface which confronts said first friction wall surface, and an internally threaded portion which is disposed opposite to said second friction wall surface radially and which is movable in the axial direction between a fully engaged position, where said externally threaded surface is in a full threaded engagement with said internally threaded portion as a result of a clockwise rotation of one of said left and right ends of said axle, which corresponds to a forward movement of the wheel body, such that said second friction wall surface is frictionally engaged with said first friction wall surface to transmit the drive force through said engaging segment to said hub shell, thereby rotating the wheel body, and a partially engaged position, where said externally threaded surface is in a partial threaded engagement with said internally threaded portion as a result of a screwing-out movement of said internally threaded portion relative to said externally threaded surface, such that said second friction wall surface is disengaged from said first friction wall surface to place the wheel body in a freewheeling state, and
a coupling end disposed opposite to said engaging end in the axial direction, and extending towards said second lateral end; and
a coil spring disposed around said abutting segment to bias said second friction wall surface to move towards said first friction wall surface such that when the clockwise rotation of said one of said left and right ends of said axle is terminated suddenly by arresting turning movement of a corresponding one of the left and right pedals while the forward movement of the wheel body continues as a result of inertia, said internally threaded portion rotates relative to said externally threaded surface in a screwing-out movement against biasing action of said coil spring so as to be disposed in the partially engaged position, thereby placing the wheel body in the freewheeling state.

2. The wheel driving device according to claim 1, wherein said engaging end of said coupling socket has a third friction wall surface which is disposed opposite to said second friction wall surface in the axial direction and which confronts said intermediate wall portion in a radial direction relative to the axis, said axle further including an interconnecting segment which is interposed between said left annular race segment and said abutting segment,
said wheel driving device further comprising
a tubular mount including outer and inner tubular surfaces opposite to each other in radial directions relative to the axis, said outer tubular surface being adapted to be suspended from the left mount, and including a friction region which extends into said surrounding accommodation space and proximate to said abutting segment, said inner tubular surface being disposed to surround said interconnecting segment so as to permit said interconnecting segment to rotate relative thereto, and
a brake member which is disposed in said surrounding accommodation space, said brake member having a fourth friction wall surface which confronts said third friction wall surface, an abutment wall surface which is opposite to said fourth friction wall surface in a radial direction relative to the axis and which is disposed to confront said inner peripheral wall surface of said hub shell, and a fifth friction wall surface which is opposite to said fourth friction wall surface in the axial direction and which is disposed to confront said friction region, said brake member being disposed to be movable in the axial direction between a freewheeling position, where said internally threaded portion is in the partial engaged position, and where said third friction wall surface is disengaged from said fourth friction wall surface, and a braked position, where said internally threaded portion is in a slight threaded engagement with said externally threaded surface as a result of a counterclockwise rotation of one of said left and right ends of said axle by virtue of backpedaling, and where said fourth and fifth friction wall surfaces and said abutment wall surface respectively engage said third friction wall surface, said friction region and said inner peripheral wall surface of said hub shell as a result of a leftward displacement of said brake member due to movement of said internally threaded portion from said partially engaged position to said braked position.

3. The wheel driving device according to claim 2, wherein said coupling end of said coupling socket includes a tubular portion to receive and surround said abutting segment and said coil spring, said tubular portion having outer and inner surrounding surfaces opposite to each other in radial directions relative to the axis, said wheel driving device further comprising left and right limit members which are spaced apart in the axial direction, and which are disposed on said abutting segment proximate to said friction region, and on said inner surrounding surface, respectively, so as to confine said coil spring therebetween, thereby permitting said coil spring to bias said second friction wall surface to move towards said first friction wall surface.

4. The wheel driving device according to claim 3, wherein said brake member includes an inner surrounding guiding wall extending in the axial direction and communicating with said fourth friction wall surface so as to receive and surround said tubular portion such that said inner surrounding guiding wall is in slidable contact with said outer surrounding surface of said tubular portion so as to stabilize the movement of said coupling socket in the axial direction.

5. The wheel driving device according to claim 2, wherein said left antifriction bearing includes outer and inner annular race regions which are disposed on said outer tubular surface of said tubular mount and which are respectively distal from and proximate to said friction region in the axial direction, and a plurality of first rollers and a plurality of second rollers respectively disposed between said outer annular race region and said left annular race segment, and between said inner annular race region and said second lateral end of said hub shell.
